(19) United States
(12) Patent Application Publication
(10) Pub. No.: US 2026/0117977 A1
(43) Pub. Date: Apr. 30, 2026

(54) HYDROGEN NOZZLE WITH MULTIPLE FLOW CIRCUITS AND FLOW DIRECTING SWIRLER

(71) Applicant: PRATT & WHITNEY CANADA CORP., Longueuil (CA)

(72) Inventors: Luca Agopian, Montreal (CA); Jean-Rene Poulin, Saint-Hubert (CA); Mathieu Fagnan, Lasalle (CA)

(21) Appl. No.: 19/370,407

(22) Filed: Oct. 27, 2025

Related U.S. Application Data
(60) Provisional application No. 63/712,955, filed on Oct. 28, 2024.

(51) Int. Cl. F23R 3/14; B22F 10/28; B22F 10/62; B33Y 10/00; B33Y 40/20; B33Y 70/00; B33Y 80/00

(52) U.S. Cl. CPC F23R 3/14; B22F 10/28; B22F 10/62; B33Y 10/00; B33Y 40/20; B33Y 70/00; B33Y 80/00

(57) ABSTRACT

A hydrogen fuel nozzle for a gas turbine engine includes a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits. The hydrogen fuel nozzle is formed using an additive manufacturing (AM) technique from a hydrogen-compatible alloy and wherein an inside diameter of the hydrogen flow circuit has a surface finish selected to limit hydrogen embrittlement.

### CROSS-REFERENCE TO RELATED APPLICATION(S)

This application claims the benefit of U.S. Provisional Application No. 63/712,955, filed Oct. 28, 2024, and entitled “Hydrogen Nozzle with Multiple Flow Circuits and Flow Directing Swirler,” the disclosure of which is hereby incorporated by reference in its entirety.

### BACKGROUND

The present disclosure relates generally to a hydrogen fuel nozzle for a gas turbine engine and, more particularly, to a hydrogen fuel nozzle made for a gas turbine engine with additive manufacturing (AM) techniques.

The use of hydrogen as an alternative fuel for aircraft engines has gained attention in recent years due to an increased demand for sustainable fuels. Incorporating hydrogen as an aircraft engine fuel in a feasible manner brings certain challenges. One of these challenges is leakage that may occur in traditional jointed components due to the small size of hydrogen molecules. Hydrogen molecules that may leak into connected joints can cause hydrogen embrittlement and premature combustion. Further, hydrogen embrittlement can occur in metal parts is in contact with hydrogen molecules, such as fuel nozzles or fuel injectors, regardless of leakage.

### SUMMARY

One aspect of this disclosure is directed to a hydrogen fuel nozzle for a gas turbine engine having a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits. The hydrogen fuel nozzle is formed using an additive manufacturing (AM) technique from a hydrogen-compatible alloy and wherein an inside diameter of the hydrogen flow circuit has a surface finish selected to limit hydrogen embrittlement.

Another aspect of the disclosure is directed to a method of making a hydrogen fuel nozzle for a gas turbine engine. A hydrogen fuel nozzle is integrally formed from a hydrogen-compatible alloy using a continuous AM technique. The hydrogen fuel nozzle has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits. The hydrogen fuel nozzle is post-processed to remove support structures formed in the hydrogen fuel nozzle during the AM process. A surface finishing operation is performed on the hydrogen flow circuit to provide an inside diameter of the hydrogen flow circuit with a surface finish selected to limit hydrogen embrittlement.

### BRIEF DESCRIPTION OF THE DRAWINGS

FIG. 1A is a schematic view of a hydrogen fuel nozzle for a gas turbine engine positioned on a powder bed fusion (PBF) additive manufacturing (AM) build plate.

FIG. 1B is another schematic view of a hydrogen fuel nozzle for a gas turbine engine positioned on a powder bed fusion (PBF) additive manufacturing (AM) build plate.

FIG. 2 is a flow chart of a method for building a hydrogen fuel nozzle for a gas turbine engine.

FIG. 3A is a schematic view of a hydrogen flow passage with a rough (“as built”) internal diameter surface.

FIG. 3B is a schematic view of a hydrogen flow passage after a surface finishing operation to smooth the internal diameter surface.

FIG. 4A is a schematic view of an optional configuration for a hydrogen fuel nozzle of the present disclosure.

FIG. 4B is a schematic view of another optional configuration for a hydrogen fuel nozzle of the present disclosure.

FIG. 4C is a schematic view of yet another optional configuration for a hydrogen fuel nozzle of the present disclosure.

FIG. 5A is a schematic view of an optional configuration for a hydrogen fuel nozzle of the present disclosure including a first configuration swirler in one of the flow circuits.

FIG. 5B is a schematic view of an optional configuration for a hydrogen fuel nozzle of the present disclosure including another swirler configuration in one of the flow circuits.

FIG. 6A is a schematic view of a single swirler in a flow circuit for a hydrogen fuel nozzle of the present disclosure.

FIG. 6B is a schematic view of a double swirler in a flow circuit for a hydrogen fuel nozzle of the present disclosure.

### DETAILED DESCRIPTION

As discussed, because hydrogen is under consideration as a fuel for aircraft engines, certain challenges must be addressed. These challenges include hydrogen embrittlement and hydrogen leakage across connected joints. One approach to addressing hydrogen leakage across connected joints is to use jointless manufacturing techniques, including additive manufacturing (AM) techniques. AM techniques can reduce or eliminate the need for connected joints with good engineering design approaches and effective use of AM techniques. Further, AM techniques can be used to form complicated geometrical features that may be desirable for a hydrogen fuel nozzle, such as various swirling or fuel premixing features.

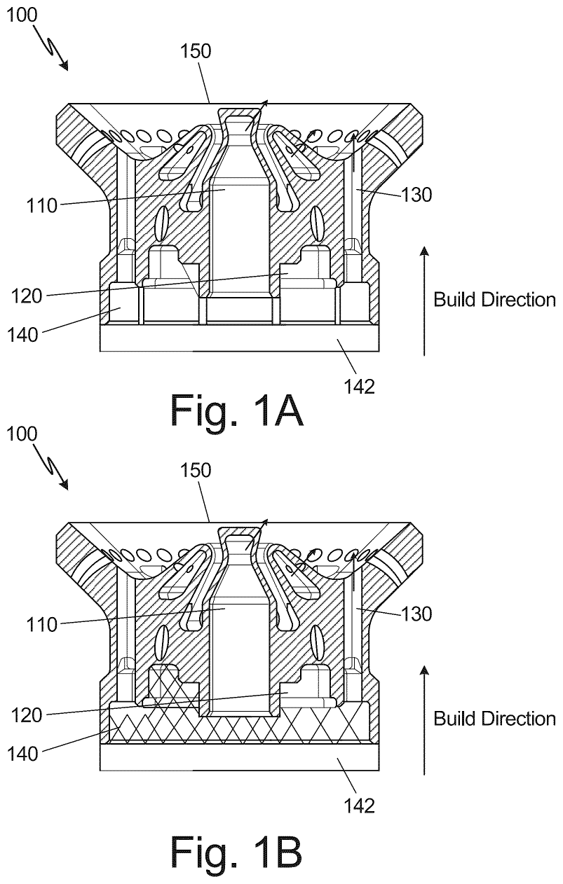

FIGS. 1A and 1B are schematics of a hydrogen fuel nozzle 100 that includes a plurality of flow circuits, each of which is configured to flow one of a fuel or an oxidizer (e.g., air) to a gas turbine engine combustor (not shown) positioned downstream of the hydrogen fuel nozzle 100 when the gas turbine engine is assembled. As discussed further below, at least one of the plurality of flow circuits is configured to flow hydrogen to the gas turbine engine combustor. For example, the hydrogen fuel nozzle 100 of FIGS. 1A and 1B include a primary flow circuit 110, a secondary flow circuit 120, and a tertiary flow circuit 130. A person of ordinary skill will recognize the hydrogen fuel nozzle 100 may include more then or fewer than three flow circuits 110, 120, 130. FIGS. 1A and 1B also show a plurality of support structures 140 formed adjacent to a AM manufacturing system build plate 142. FIG. 1A shows the plurality of support structures 140 as formed during the AM build process. FIG. 1B shows with overlaid “X”'s, which of the plurality of support structures 140 are removed in a post AM build processing operation. In some examples, all of the flow circuits can be directed to hydrogen. In other examples, at least one of the flow circuits can be directed to hydrogen with the remaining flow circuits being directed to air. In yet other examples, one of the flow circuits can be directed to a liquid hydrocarbon fuel (e.g., Jet A, a sustainable aviation fuel equivalent to Jet A, or another liquid hydrocarbon fuel), another of the flow circuits can be directed to air, and another of the flow circuits can be directed to hydrogen. In the examples of FIGS. 1A and 1B, the primary flow circuit 110 can be directed to a liquid hydrocarbon fuel, the secondary flow circuit 120 can be directed to air, and the tertiary flow circuit 130 can be directed to hydrogen. The assignment of liquid fuel, air, and hydrogen to a particular flow circuit can be selected based on whatever arrangement is deemed appropriate for a particular application. For an application such as the hydrogen fuel nozzle 100, hydrogen can be provided as a pressurized gas so that it mixes well with liquid fuel and air streams.

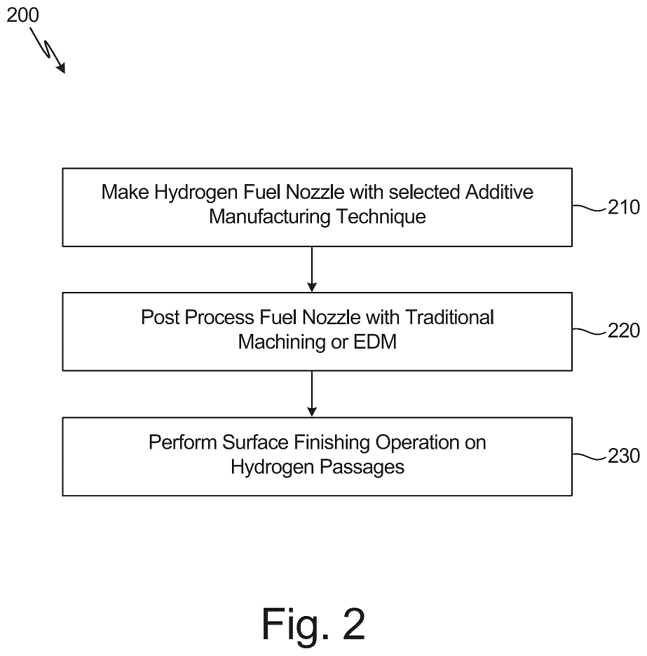

FIG. 2 is a flow chart of an overall process 200 for building a hydrogen fuel nozzle 100 of this disclosure. At step 210, a selected AM technique is used to make the hydrogen fuel nozzle 100. The AM technique can be any AM technique deemed suitable for a particular hydrogen fuel nozzle 100. For example, the selected AM technique can be Powder Bed Fusion, e.g., Laser Powder Bed Fusion (PBF-LB) or Electron Beam Powder Bed Fusion (PBF-EB), Binder Jetting, Metal Extrusion (MEX), or any other AM technique deemed suitable for a particular hydrogen fuel nozzle 100. The considerations that can be used to select a particular AM technique for making the hydrogen fuel nozzle 100 can include, but are not limited to
, the material from which the fuel nozzle 100 will be made, the specific details of the hydrogen fuel nozzle 100 that will be made with AM techniques, and the surface finish produced by the selected AM technique.

Because of the challenges associated with hydrogen embrittlement, the hydrogen fuel nozzle 100 should be made with a hydrogen-compatible alloy designed to limit the impact of hydrogen embrittlement. Examples of such materials include Inconel® 600 nickel-chromium-iron superalloy, Inconel® 625 nickel-chromium superalloy, NASA HR-1 iron-nickel superalloy, and similar alloys. For use with a PBF AM technique, the material should be provided in powder form, with a powder meeting the specifications associated with the PBF AM technique.

At step 220, the hydrogen fuel nozzle 100 made with the selected AM technique of step 210 can be subjected to one or more selected post-processing steps depending on the selected AM technique. For example, the one or more selected post-processing steps may be used to remove support structures 140 at the bottom of the build plate 142 used to create features that may not be possible with selected AM technique, or used for any other purpose deemed appropriate for a particular hydrogen nozzle 100. Examples of suitable post-processing steps include mechanical machining (e.g., grinding, cutting, drilling, milling, etc.), chemical processing (e.g., chemical material removal processes, coating processes, etc.), electro-discharge machining (EDM), or other post-processing methods. In one example, an EDM post-processing step can be used to create features that may not be possible with current AM techniques.

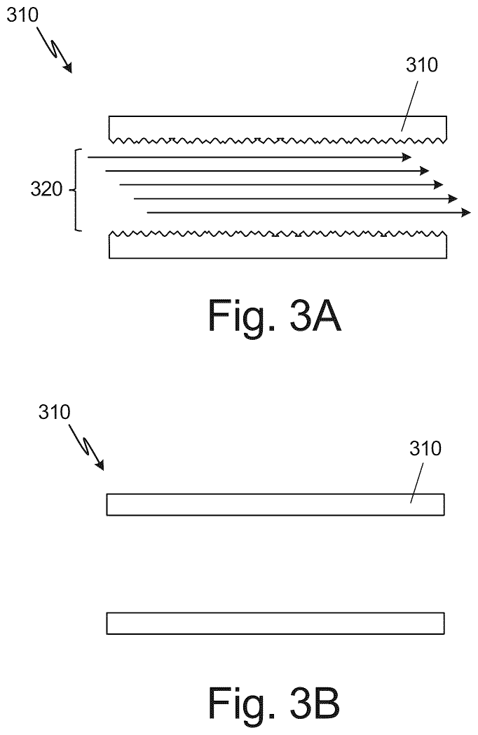

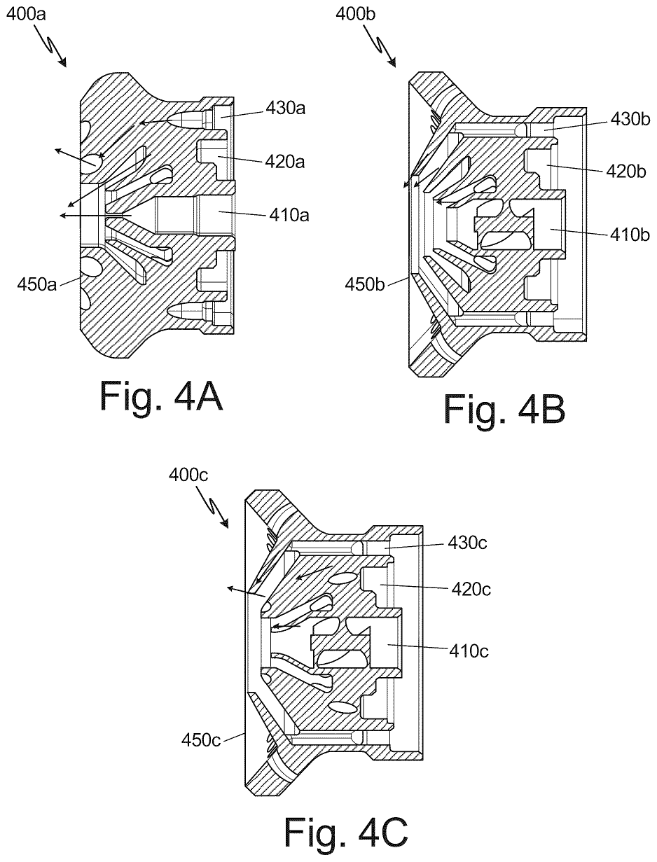

At step 230, selected passageways in one of the plurality of flow circuits 110, 120, 130 in hydrogen fuel nozzle 100, particularly passageways that are configured for hydrogen flow, are polished to achieve a desired surface finish. Exemplary polishing processes include chemical milling, chemical/mechanical etching, a selected electrochemical process or any other suitable polishing process may be used to produce a desired surface finish. FIGS. 3A and 3B show such a polish process schematically, with FIG. 3A showing a selected hydrogen flow passage 310 having an inside diameter (ID) surface 320 with a rough (“as built”) surface finish. FIG. 3A also shows selected chemical finishing reagent 330 flowed through the ID surface 320. The chemical reagent 330 is selected to perform a chemical milling operation on ID surface 320 to produce a desired smoother surface finish. FIG. 3B shows that the same selected hydrogen flow passage 310 after the chemical milling step has an ID surface 320 with a smooth surface finish selected to limit hydrogen embrittlement. Providing an ID surface 320 a smooth surface finish reduces hydrogen embrittlement by reducing the surface area available for direct hydrogen contact and removing fissures and pores in which hydrogen can accumulate. Achieving the desired smoother surface finish for ID surface 320 may require plugging some flow circuit 110, 120, 130 holes as discussed further below to limit the chemical milling operation to selected passageways (see FIGS. 4A-4C).

While the desired specific improvement in ID surface 320 surface finish can vary from application to application, the overall goal of step 230 is to reduce the roughness of the ID surface 320 to form a much smoother surface finish then available by AM techniques only. For example, depending on the specific application, it may be desirable to achieve an average surface roughness of less than 20 μm for a particular ID surface 320. In other applications, particularly applications that will involve extensive use of hydrogen fuel, it may be desirable to achieve an average surface roughness of less than 5 μm or even less than 3 μm for ID surface 320 used in a hydrogen fuel flow circuit.

Suitable chemical milling reagents can include hydrochloric acid (HCl), nitric acid (HNO₃), other chemical milling reagents, and mixtures of chemical milling reagents including dilutions of chemical milling reagents with an alcohol such as ethanol or another alcohol. Other reagents are also possible depending on the material used to build the hydrogen fuel nozzle 100. In some examples, polish techniques other than chemical milling can be used to improve the surface finish of ID surface 320. For example, mechanical milling or other mechanical, electrical, or chemical methods can be used to improve the surface finish of ID surface 320.

FIGS. 4A-4C show various options for a hydrogen fuel nozzle 400a, 400b, 400c of this disclosure. These options may include one or more of:
Different hydrogen passage sizes leading to provide different hydrogen velocities from one or more of the flow channels 410, 420, 430. Such a configuration can contribute to controlling flame penetration, pre-mixing, and flame detachment from the hydrogen nozzle tip 450.
The hydrogen fuel passages can be oriented in different combinations of co-flow, straight thru, or cross flow designs (See FIG. 4B).
The hydrogen fuel passages can have the exit orifices as discrete passages such as holes, slots, or an annulus (Compare FIGS. 1A/1B with 4A/4B/4C).
The hydrogen fuel passage exit orifices can have co-swirl and counter swirl orientation that can be alternated or maintained the same for all circuits to have better mixing when hydrogen flows through more than one fuel circuit depending on the flow regime.
The hydrogen fuel channel can have the same or different exit planes as the air in the air flow channel. (See FIG. 4C)
The hydrogen fuel channels can feed into a common exit passage. (See FIG. 4B)

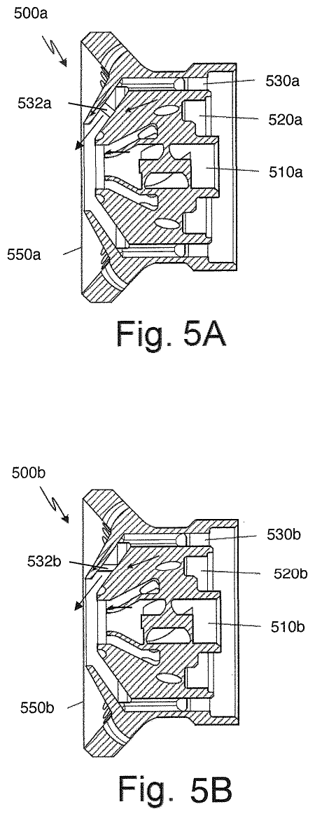

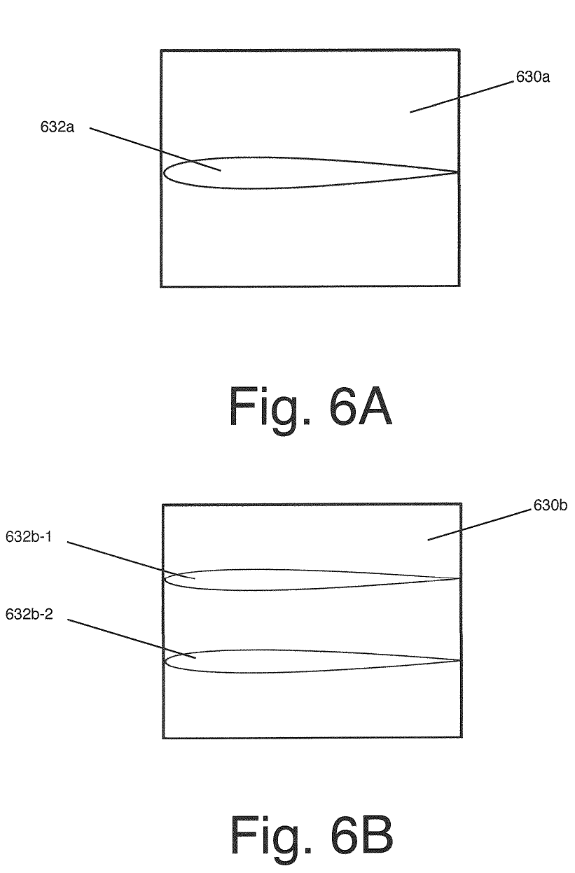

FIG. 5A to FIG. 6B show various other options for a hydrogen fuel nozzle 500a, 500b of this disclosure. FIGS. 5A and 5B shows one or more swirlers 532a, 532b positioned in tertiary flow circuit 530a, 530b. The one or more swirlers 532a, 532b are configured to direct flow through the tertiary flow circuit 530a, 530b in a desired direction and can also function as supports during an AM process by which the hydrogen fuel nozzle 500a, 500b is made. The one or more swirlers 532a in FIG. 5A are positioned such that an airfoil portion of the swirler(s) is perpendicular to the direction of flow through the tertiary flow circuit 530a. The one or more swirlers 532b in FIG. 5B are positioned such that an airfoil portion of the swirler(s) is at an acute angle to the direction of flow through the tertiary flow circuit 530b. As demonstrated by FIGS. 5A and 5B the angle of the one or more swirlers 532a, 532b with regard to the direction of flow through the flow circuit can be selected as deemed appropriate for a particular application. Although FIGS. 5A and 5B show the one or more swirlers 532a, 532b positioned in tertiary flow circuit 530a, 530b, similar swirlers can be positioned in any of the other flow circuits or any number of the flow circuits.

FIG. 6A shows a single swirler 632a in a flow circuit 630a for a hydrogen fuel nozzle of the present disclosure. FIG. 6B shows a double swirler 632b-1, 632b-2 in a flow circuit 630b for a hydrogen fuel nozzle of the present disclosure. In other examples, more than two swirlers can be positioned in a hydrogen fuel nozzle for circuit if deemed appropriate for a particular application. As discussed above, any number swirlers can be positioned in any of the other flow circuits or any number of the flow circuits if deemed appropriate for a particular application.

The disclosed hydrogen fuel nozzles address many of the challenges associated with using hydrogen as a fuel for aircraft engines. These include use of AM techniques to reduce or eliminate the need for connected joints and the use of hydrogen-compatible alloys that are less susceptible to hydrogen embrittlement.

### DISCUSSION OF POSSIBLE EMBODIMENTS

The following are non-exclusive descriptions of possible embodiments of the present invention.

A hydrogen fuel nozzle for a gas turbine engine includes a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits. The hydrogen fuel nozzle is formed using an additive manufacturing (AM) technique from a hydrogen-compatible alloy and wherein an inside diameter of the hydrogen flow circuit has a surface finish selected to limit hydrogen embrittlement.

The component protection casing of the preceding paragraph can optionally include, additionally and/or alternatively, any one or more of the following features, configurations and/or additional elements:

The one or more swirlers positioned inside the at least one of the plurality of flow circuits include an airfoil portion positioned perpendicular to the direction of flow through the at least one of the plurality of flow circuits.

The one or more swirlers positioned inside the at least one of the plurality of flow circuits include an airfoil portion positioned at an acute angle to the direction of flow through the at least one of the plurality of flow circuits.

The one or more swirlers are positioned inside more than one of the plurality of flow circuits.

The hydrogen-compatible alloy is one of Inconel® 600 nickel-chromium-iron superalloy, Inconel® 625 nickel-chromium superalloy, NASA HR-1 iron-nickel superalloy.

The desired surface finish of the inside diameter of the hydrogen flow circuit is established with a chemical milling process using a selected chemical reagent.

The selected reagent is one of hydrochloric acid (HCl) and nitric acid (HNO3).

The inside diameter of the hydrogen flow circuit has an average surface roughness of less than 20 μm after chemical milling.

The inside diameter of the hydrogen flow circuit has an average surface roughness of less than 5 μm after chemical milling.

The hydrogen fuel nozzle has three flow circuits.

A primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

A method of making a hydrogen fuel nozzle for a gas turbine engine includes integrally forming a hydrogen fuel nozzle from a hydrogen-compatible alloy using a continuous AM technique. The hydrogen fuel nozzle has a plurality of flow circuits, each of which is configured to flow one of a fuel or an oxidizer to a gas turbine engine combustor positioned downstream of the hydrogen fuel nozzle when the gas turbine engine is assembled. At least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits. The hydrogen fuel nozzle is post-processed to remove support structures formed in the hydrogen fuel nozzle during the AM process. A surface finishing operation is performed on the hydrogen flow circuit to provide an inside diameter of the hydrogen flow circuit with a surface finish selected to limit hydrogen embrittlement.

The method of the preceding paragraph can optionally include, additionally and/or alternatively, any one or more of the following features, configurations and/or additional elements:

The one or more swirlers positioned inside the at least one of the plurality of flow circuits include an airfoil portion positioned perpendicular to the direction of flow through the at least one of the plurality of flow circuits.

The one or more swirlers positioned inside the at least one of the plurality of flow circuits include an airfoil portion positioned at an acute angle to the direction of flow through the at least one of the plurality of flow circuits.

The one or more swirlers are positioned inside more than one of the plurality of flow circuits.

The hydrogen-compatible alloy is one of Inconel® 600 nickel-chromium-iron superalloy, Inconel® 625 nickel-chromium superalloy, NASA HR-1 iron-nickel superalloy.

The surface finishing operation is a chemical milling process using a selected chemical reagent.

The inside diameter of the hydrogen flow circuit has an average surface roughness of less than 20 μm after the surface finishing operation.

The inside diameter of the hydrogen flow circuit has an average surface roughness of less than 5 μm after the surface finishing operation.

The hydrogen fuel nozzle is formed with three flow circuits.

A primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A hydrogen fuel nozzle for a gas turbine engine comprising:
a plurality of flow circuits, each of which is configured to flow one of a fuel or an oxidizer to a gas turbine engine combustor positioned downstream of the hydrogen fuel nozzle when the gas turbine engine is assembled, wherein at least one of the plurality of flow circuits is a hydrogen flow circuit configured to flow hydrogen to the gas turbine engine combustor and at least one of the plurality of flow circuits includes one or more swirlers positioned inside the at least one of the plurality of flow circuits to direct flow through the at least one of the plurality of flow circuits;
wherein the hydrogen fuel nozzle is formed using an additive manufacturing (AM) technique from a hydrogen-compatible alloy and wherein an inside diameter of the hydrogen flow circuit has a surface finish selected to limit hydrogen embrittlement.

2. The hydrogen fuel nozzle of claim 1, wherein the one or more swirlers positioned inside the at least one of the plurality of flow circuits include an airfoil portion positioned perpendicular to the direction of flow through the at least one of the plurality of flow circuits.

3. The hydrogen fuel nozzle of claim 1, wherein the one or more swirlers positioned inside the at least one of the plurality of flow circuits include an airfoil portion positioned at an acute angle to the direction of flow through the at least one of the plurality of flow circuits.

4. The hydrogen fuel nozzle of claim 1, wherein the one or more swirlers are positioned inside more than one of the plurality of flow circuits.

5. The hydrogen fuel nozzle of claim 1, wherein the hydrogen-compatible alloy is one of Inconel® 600 nickel-chromium-iron superalloy, Inconel® 625 nickel-chromium superalloy, NASA HR-1 iron-nickel superalloy.

6. The hydrogen fuel nozzle of claim 1, wherein the desired surface finish of the inside diameter of the hydrogen flow circuit is established with a chemical milling process using a selected chemical reagent.

7. The hydrogen fuel nozzle of claim 6, wherein the inside diameter of the hydrogen flow circuit has an average surface roughness of less than 20 μm after chemical milling.

8. The hydrogen fuel nozzle of claim 7, wherein the inside diameter of the hydrogen flow circuit has an average surface roughness of less than 5 μm after chemical milling.

9. The hydrogen fuel nozzle of claim 1 having three flow circuits.

10. The hydrogen fuel nozzle of claim 9, wherein a primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.

11. A method of making a hydrogen fuel nozzle for a gas turbine engine comprising:
integrally forming, using a continuous additive manufacturing (AM) technique, a hydrogen fuel nozzle from a hydrogen-compatible alloy, wherein the hydrogen fuel nozzle has a plurality of flow circuits, wherein each of the plurality of flow circuits is configured to flow one of a fuel or an oxidizer to a gas turbine engine combustor positioned downstream of the hydrogen fuel nozzle when the gas turbine engine is assembled and at least one of the plurality of flow circuits includes one or more swirlers positioned inside the at least one of the plurality of flow circuits to direct flow through the at least one of the plurality of flow circuits, and wherein at least one of the plurality of flow circuits is a hydrogen flow circuit configured to flow hydrogen to the gas turbine engine combustor;
post-processing the hydrogen fuel nozzle to remove support structures formed in the hydrogen fuel nozzle during the AM process; and
performing a surface finishing operation on the hydrogen flow circuit to provide an inside diameter of the hydrogen flow circuit with a surface finish selected to limit hydrogen embrittlement.

12. The method of claim 11, wherein the one or more swirlers positioned inside the at least one of the plurality of flow circuits include an airfoil portion positioned perpendicular to the direction of flow through the at least one of the plurality of flow circuits.

13. The method of claim 11, wherein the one or more swirlers positioned inside the at least one of the plurality of flow circuits include an airfoil portion positioned at an acute angle to the direction of flow through the at least one of the plurality of flow circuits.

14. The method of claim 11, wherein the one or more swirlers are positioned inside more than one of the plurality of flow circuits.

15. The method of claim 11, wherein the hydrogen-compatible alloy is one of Inconel® 600 nickel-chromium-iron superalloy, Inconel® 625 nickel-chromium superalloy, NASA HR-1 iron-nickel superalloy.

16. The method of claim 11, wherein the surface finishing operation is a chemical milling process using a selected chemical reagent.

17. The method of claim 16, wherein the inside diameter of the hydrogen flow circuit has an average surface roughness of less than 20 μm after the surface finishing operation.

18. The method of claim 17, wherein the inside diameter of the hydrogen flow circuit has an average surface roughness of less than 5 μm after the surface finishing operation.

19. The method of claim 11, wherein the hydrogen fuel nozzle is formed with three flow circuits.

20. The method of claim 19, wherein a primary flow circuit is configured to flow a liquid hydrocarbon fuel to the gas turbine engine combustor, a secondary flow circuit is configured to flow an oxidizer to the gas turbine engine combustor, and a tertiary flow circuit is configured to flow hydrogen to the gas turbine engine combustor.
